(19) United States
(12) Patent Application Publication
(10) Pub. No.: US 2018/0121310 A1
(43) Pub. Date: May 3, 2018

(54) Computer Utilization Monitoring System

(71) Applicant: Party of Five, LLLP, Broomfield, CO (US)

(72) Inventors: Jonathan P. File, Broomfield, CO (US); Joelle P. File, Broomfield, CO (US)

(73) Assignee: Party of Five, LLLP, Broomfield, CO (US)

(21) Appl. No.: 15/797,628

(22) Filed: Oct. 30, 2017

Related U.S. Application Data
(60) Provisional application No. 62/415,914, filed on Nov. 1, 2016.

(51) Int. Cl. G06F 11/34; H04L 29/08; G06F 3/0481; G06F 3/0482

(52) U.S. Cl. CPC G06F 11/3438; G06F 11/3419; G06F 3/0482; G06F 3/04817; H04L 67/22

(57) ABSTRACT

A computer utilization monitoring system in the form of a server and a server processor communicatively coupled to a server memory containing a computer program having computer-executable instructions which can be served in whole or in part to one or a plurality of computing devices to monitor and calculate accrued unpermitted usage of each of the plurality of computing devices.

This United States Non-Provisional Patent Application claims the benefit of United States Provisional Patent Application No. 62/415,914, filed Nov. 1, 2016, hereby incorporated by reference herein.

### I. FIELD OF THE INVENTION

A computer utilization monitoring system in the form of a server and a server processor communicatively coupled to a server memory containing a computer program having computer-executable instructions which can be served in whole or in part to one or a plurality of computing devices to monitor and calculate accrued unpermitted usage of each of the plurality of computing devices.

### II. BRIEF DESCRIPTION OF THE DRAWINGS

FIG. 1 illustrates a block diagram of a particular embodiment of the computer utilization monitoring system.

FIG. 2 illustrates a particular embodiment of a graphical user interface depicted on the display surface of an administrator computing device including a run time menu which displays an administrator overview image including indications of accrued unpermitted usage of each of a plurality of computing devices.

FIG. 3 illustrates depiction of a particular embodiment of a detail image of the accrued unpermitted usage of one of a plurality of computing devices listed in the overview image of FIG. 2.

FIG. 4 illustrates depiction of a particular embodiment of a detail report of the accrued unpermitted usage of the computing device listed in the detail image of FIG. 3 which includes an amount of time associated with the unpermitted usage of particular applications, telephone calls, and text messaging.

FIG. 5 illustrates a particular embodiment of a graphical user interface depicted on the display surface of an administrator computing device including a setup menu which displays a computing device administration image which by user interaction allows data associated with one or more computing devices to entered and managed in the computer utilization monitoring system.

FIG. 6 illustrates depiction of a particular embodiment of review image which by user interaction confirms data associated with the one or more computing devices to be entered into the computer utilization monitoring system.

FIG. 7 illustrates depiction of a particular embodiment of an export image which by user interaction allows selection from the plurality of computing devices entered into the computer utilization monitoring system to be monitored within a specified calendar period.

FIG. 8 illustrates depiction of a particular embodiment of a permitted usage entry image which by user interaction allows entry of one or more permitted usage events into the computer utilization monitoring system.

FIG. 9 illustrates a particular embodiment of a graphical user interface which depicts a run time menu on the display surface of a client computing device including a monitoring start image which by user interaction starts monitoring of unpermitted usage events by the computer utilization monitoring system.

FIG. 10 illustrates depiction of a monitoring pause image which by user interaction pauses monitoring of unpermitted usage events by the computer utilization monitoring system.

FIG. 11 illustrates depiction of a monitoring end image which by user interaction ends monitoring of unpermitted usage events by the computer utilization monitoring system.

FIG. 12 illustrates a depiction of a client overview image including indications of accrued unpermitted usage of the computing device.

### III. DETAILED DESCRIPTION OF THE INVENTION

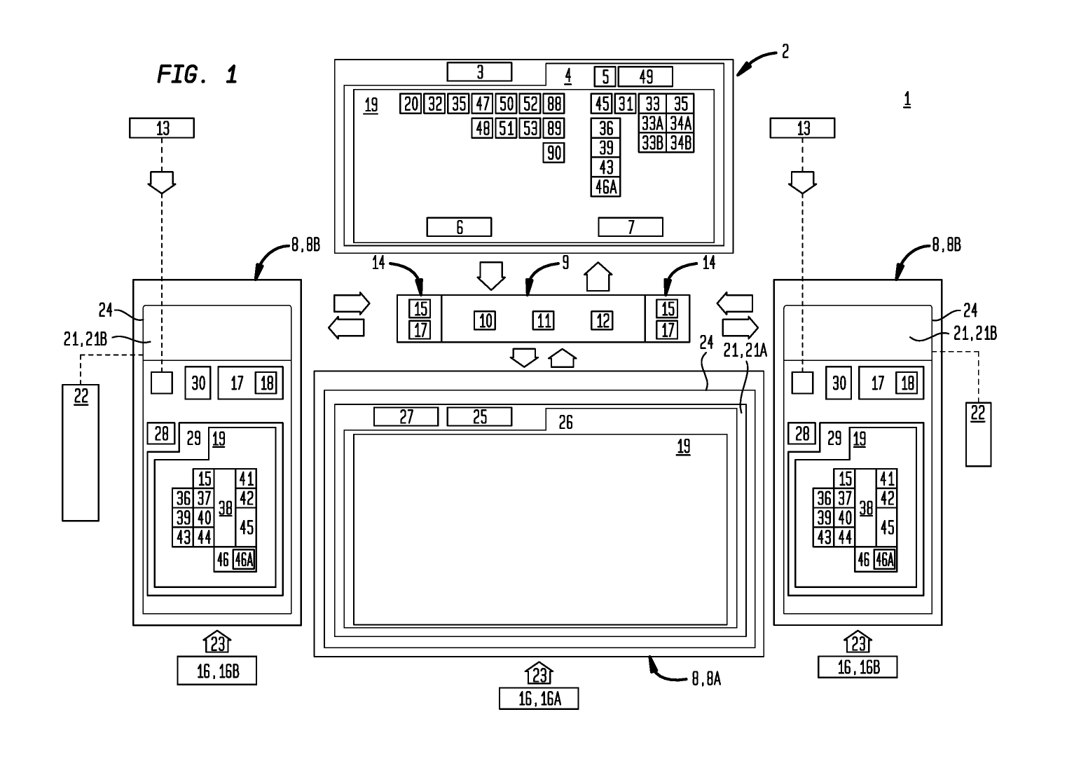

Now referring primarily to FIG. 1, which illustrates a computer utilization monitoring system (1)(also referred to as the “system”) which may be distributed on one or more servers (2), each having a server processor (3), a server memory (4), a server operating system (5), a server input/output interface (6), and a server network interface (7) operably coupled to a plurality of computing devices (8) by a public network (9) (also referred to as a “network”), such as the Internet (10), a cellular-based wireless network(s)(11), or a local network (12). The system (1) can, but need not necessarily, further include a global positioning system (“GPS”)(13) communicatively coupled to one or more of the plurality of computing devices (8).

The network (9) supports a plurality of communication resources (14)(along with other communication resources made available in the future) to afford as illustrative examples: recording, transmission, or reproduction of images (whether still or moving images), sound relating to acoustical, mechanical or electrical frequencies, electronic mail, instant messaging, text messaging (such as short message service) multimedia messaging (such as multimedia message service) attributable to the execution of self-contained programs or pieces of software designed to fulfill particular purposes (also referred to as “applications” (15)), as illustrative examples: web applications, online applications, mobile applications, one or more downloadable by a user (16) to confer computing device content (17), as illustrative examples: Internet documents, graphics, audio, and video files, voice communication, electronic mail, instant messages, graphical games, in and to corresponding one of the plurality of computing devices (8), which can include as illustrative examples: desktop or mobile computer devices such as personal computers, slate, tablet or pad computers, cellular telephones or camera/cell phones, and programmable consumer electronics.

Each of the one or more computing devices (8) can, but need not necessarily, include an Internet browser (18) (also referred to as a “browser”), as illustrative examples: Microsoft's INTERNET EXPLORER®, GOOGLE CHROME®, MOZILLA®, FIREFOX®, which functions to download and render computing device content (17) formatted in “hypertext markup language” (HTML).

In this environment, the server memory (4) can contain the inventive computer monitoring utilization program (19) (also referred to as the “program”). While embodiments of the program (19) are described in the general context of computer-executable instructions such as program modules which utilize routines, programs, objects, components, data structures, or the like, to perform particular functions or tasks or implement particular abstract data types, it is not intended that any embodiments be limited to a particular set of computer-executable instructions or protocols. The program (19) can in part include a graphical user interface module (20) which can implement one or more graphical user interface(s)(21) including one or more menus (22) including a combination of text and symbols to represent options selectable by user command (23) to execute the functions of the program (19).

As to particular embodiments, the plurality of computing devices (8) can use the Internet browser (18) to depict on the display surface (24) of the computing device (8) downloaded menus (22) and to relay selected user commands (23) back to the one or more servers (2). The one or more servers (2) can respond by formatting new menus (22) for the respective graphical user interfaces (21).

As to other embodiments, the one or more servers (2) can be used primarily as sources of computing device content (17), with primary responsibility for implementing the graphical user interface (21) being placed upon each of the one or more computing devices (8). As to these embodiments, each of the one or more computing devices (8) can run the appropriate portions of the program (19) implementing the corresponding functions including, but not limited to, the depiction of the graphical user interfaces (21).

Depending on the embodiment, the program (19) can be downloaded in whole or in part from the server (2) to an administrator computing device (8A) having an administrator computing device processor (25) communicatively coupled to an administrator computing device memory element (26)) to discretely confer all of the administrator functions (27) of the program (19) to the administrator computing device (8A) for use by an administrator user (16A). The program (19) can be further downloaded in part to a plurality of client computing devices (8B) having a client computing device processor (28) communicatively coupled to a client computing device memory element (28)) to discretely confer all of the client functions (30) of the program (19) to the client computing device (8B) for use by a plurality of client users (16B). The program (19) may also be contained on and loaded to the administrator computing device (8A) or the plurality of client computing devices (8B) from one or more of: a computer disk, universal serial bus flash drive, or other computer readable media.

The program (19) can operatively communicate with the server (2) over the network (9) to communicatively couple the administrator computing device (8A) with each of the plurality of client computing devices (8B) to coordinate or pair operation of the administrator computing device (8A) with operation of each of the client computing devices (8B). In addition to communicatively coupling the administrator computing device (8A) to each of the plurality of client devices (8B), the program (19) can further function to interrogate each client computing device (8B) to assess unpermitted usage on the client computing device (8B). As an illustrative example, the administrative computing device (8A) can attempt to connect with each client computing device (8B) every five minutes to interrogate and update the records contained in the server (2) with unpermitted usage data (31) obtained from each client computing device (8B). As to particular embodiments, the desired connectivity pattern and interrogation can, but need not necessarily, be accomplished by use of GCM Network Manager® or Firebase Cloud Messaging®, or other similar application program interfaces.

As to particular embodiments, the program (19) can, but need not necessarily, include a GPS module (32), executable to interrogate, retrieve or receive from each of the plurality of client devices (8B) a corresponding coordinate location (33). The coordinate location (33) can be a current location (33A) at a current time (34A) or as to certain embodiments a GPS timer module (35) can be executed to convert the coordinate location (33) to an expected location (33B) at a future time (34B).

As to particular embodiments, the program (19) can, but need not necessarily, include a screen lock-unlock broadcast receiver (36). The screen lock-unlock broadcast receiver (36) operates to register each event of the lock screen application (37) of the client computing device (8B). For the purposes of this invention, the term “broadcast receiver” means a portion of the program (19) which observes and responds to broadcast messages (38)(also referred to as “unpermitted usage events”) from other applications (15) on the client computing device (8B) by registering the unpermitted usage event (38) into a local database (46) contained in the client computing device memory element (29).

As to particular embodiments, the program (19) can, but need not necessarily, include a phone call broadcast receiver (39). The phone call broadcast receiver (39) operates to register each phone call (40) on the client computing device (8B), whether incoming or outgoing. Upon occurrence of a phone call (40) on the client computing device (8B), the phone call broadcast receiver (39) responds to the phone call (40) and holds the unpermitted usage event (38) relating to the phone call (40) in the local database (46). The phone call broadcast receiver (39) can function to save information relating to the phone call (40) such as the phone number, start time, end time and an incoming-outgoing flag in the local database (46). When the phone call (40) terminates a usage event time calculator (41) program (19) further functions to calculate an amount of usage time (42) associated with the phone call (40).

As to particular embodiments, the program (19) can, but need not necessarily, include a short message service receiver (43). The term short message service” means written text messages (44) typically 160 characters in length, but through the use of concatenated short message service the text message may be longer. The short message service receiver (43) operates to register each text message (44) on the client computing device (8B), whether incoming or outgoing. Upon occurrence of a text message (44) on the client computing device (8B), the short message service receiver (43) responds to the text message (44) and holds the data relating to the text message (44) in the local database (46).

As to particular embodiments, the program (19) can, but need not necessarily, include an application program interface (45) compatible with the client computing device (8B) which functions to build and save into a local database (46) an event statistics file (46A) for each application (15) on a client computing device (8B). The event statistics file (46) can include the application name, foreground time, background time. The program (19) event time calculator (41) further functions to analyze the foreground time to determine calculated usage time (42) associate with use of each application (15).

With respect to iOS operating systems, the screen lock-unlock broadcast receiver (36) can be enabled to continue running in the background by including a UIBackgroundModes or similar application (15) to the program (19) or system (1).

Now referring generally to FIGS. 1 through 12, the program (19) in part includes a graphical user interface module (20) executable to depict an administrator graphical user interface (21A) on the display surface (24) of the administrator computing device (8A) which allows the administrator user (16A) by user command (23) to execute one or more administrator functions (27) of the program (19). The graphical user interface module (20) can be further executed to depict a client graphical user interface (21B) on the display surface (24) of each of the plurality of client computing devices (8B) which allows the client user (16B) to execute one or more client functions (30) of the program (19). The administrator user (16A) and the client user (16B) interact respectively with the administrator graphical user interface (21A) or the client graphical user interface (21B) to correspondingly execute by user command (23) one or more functions (27) of the computer program (29). The term “user command” means any action by the administrator user (16A) or a client user (16B) that activates a functionality (27)(30) of the program (19) and as illustrative examples include individually, collectively or as combinations thereof: selection of one or more control icon(s), entry of text into one or more fillable fields, voice command, keyboard stroke, mouse button point and click, touch on a touch screen.

Now referring primarily to FIG. 1, embodiments of the computer program (19) can, but need not necessarily, include a sign up module (47) which upon execution depicts a sign up menu (48) which by user command (23) allows the administer user (16B) to create an account (49) which allows the administrator user (16A) to authenticate to the system (1) and potentially receive authorization to access or connect to the system (1) and load the computer program (19).

Again referring primarily to FIG. 1, embodiments of the program (19) can, but need not necessarily, include a login module (50) which upon execution depicts a login menu (51) which by user command (23) allows the administrator user (16A) or the client user (16B) to log into an account (49). To log into an account (49), an administrator user (16A) or client user (16B) authenticates oneself with a password or other credentials for the purposes of accounting, security, logging, and resource management. It is intended that terms administrator user (16A) and client user (16B) broadly encompass any relationship in which the administrator computing device (8A) monitors usage of the client computing device (8B) and therefore the relationship between administrator user (16A) and client user (16B) can as examples include: employer-employee, parent-child, physician-patient, or the like.

For the sake of brevity, the particular illustrative example depicted in FIGS. 1 through 12 and further described below, include an administrator computing device (8A) and one or more client computing devices (8B) having respective unpermitted usage events (38) monitored by operation of the program (19) and reported to the administrator computing device (8A). Embodiments of the program (19) can, but need not necessarily, include a setup module (52) which primarily by administrator user command (23) allows settings or values to be assigned to the program (19). Certain embodiments can, but need not necessarily, be provided with presets which provide settings or values automatically assigned by or to the program (19) outside of administrator user (16A) or client user (16B) intervention.

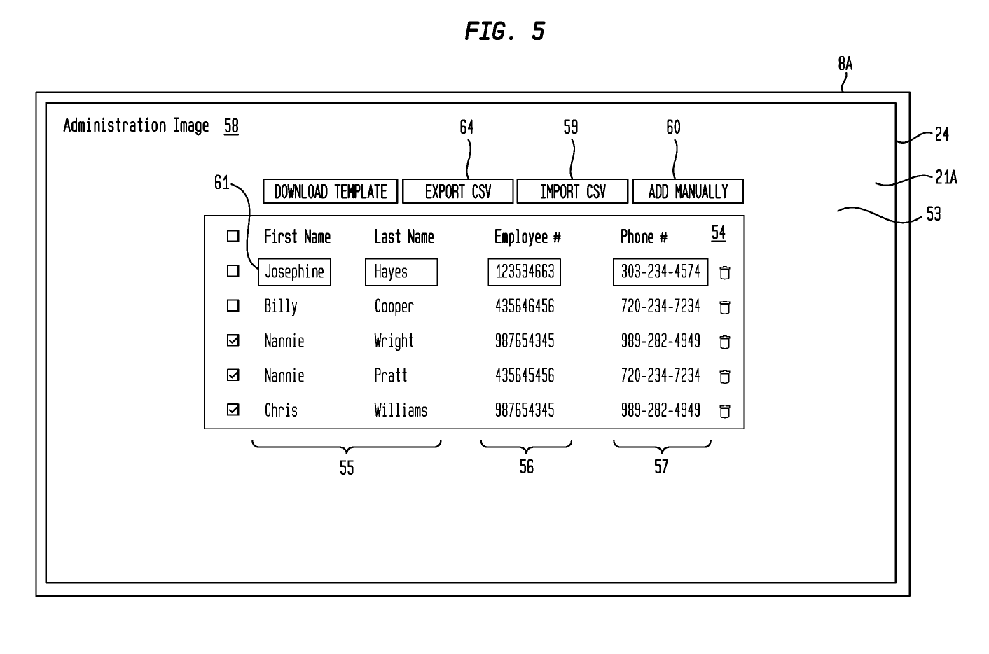

Now referring primarily to FIGS. 5 through 8, the setup module (52) can function to display a setup menu (53) on the display surface (24) of the administrative computing device (8A) including an administration image (58) by which the administrative user (16A) can input client user information (54) including one or more of: a client user name (55), client identification number (56) and the client telephone number (57)(or other identifying number) of the client computing device (8A) to be interrogated and monitored by the program (19).

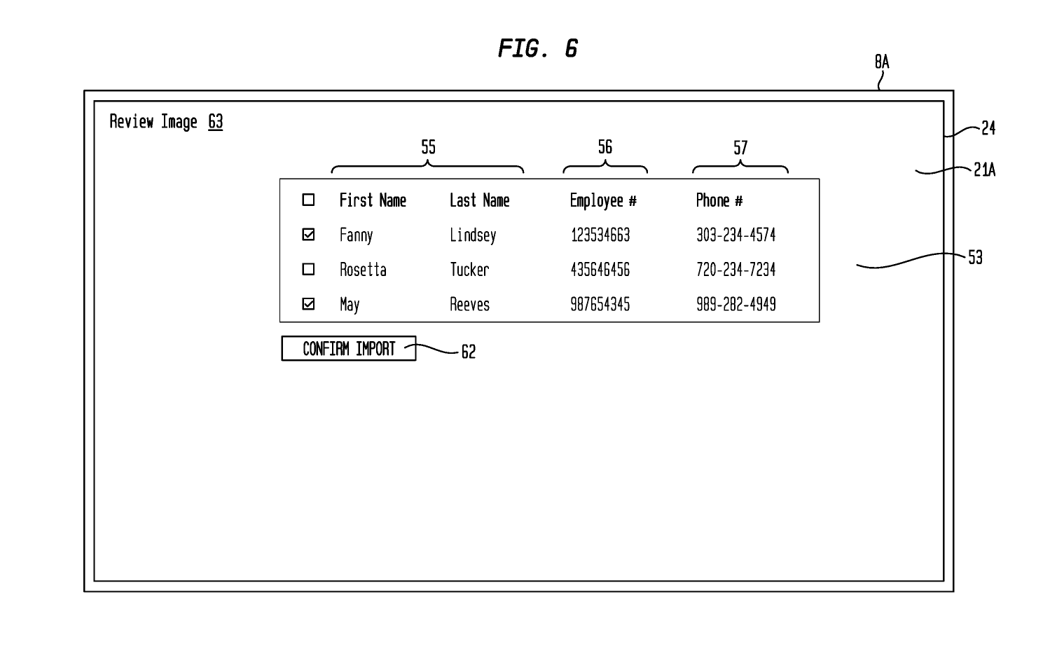

Now referring primarily to FIGS. 5 and 6, the administrator user (16A) can import client user information (54) into the system (1) by interaction with an import icon (59) or an add manually icon (60) (as shown in the example of FIG. 5) which causes the program (19) to import client information (54) from another application or depict fillable fields (61) in which the client user information (54) can be entered manually for one or more client users (16B) by the administrator user (16A). Upon entering the client user information (54), the administrator user (16A) can by interaction with an import icon (59) cause the program to retrieve and depict a review image (63) which includes the added client user information (54) as a list of client users (16B) (as shown in the example of FIG. 6). The administrator user (16A) can confirm accuracy of the client user information (54) and enter the client user information (54) into the system (1) in association with the account (49) by user interaction (23) with a “confirm import” icon (62).

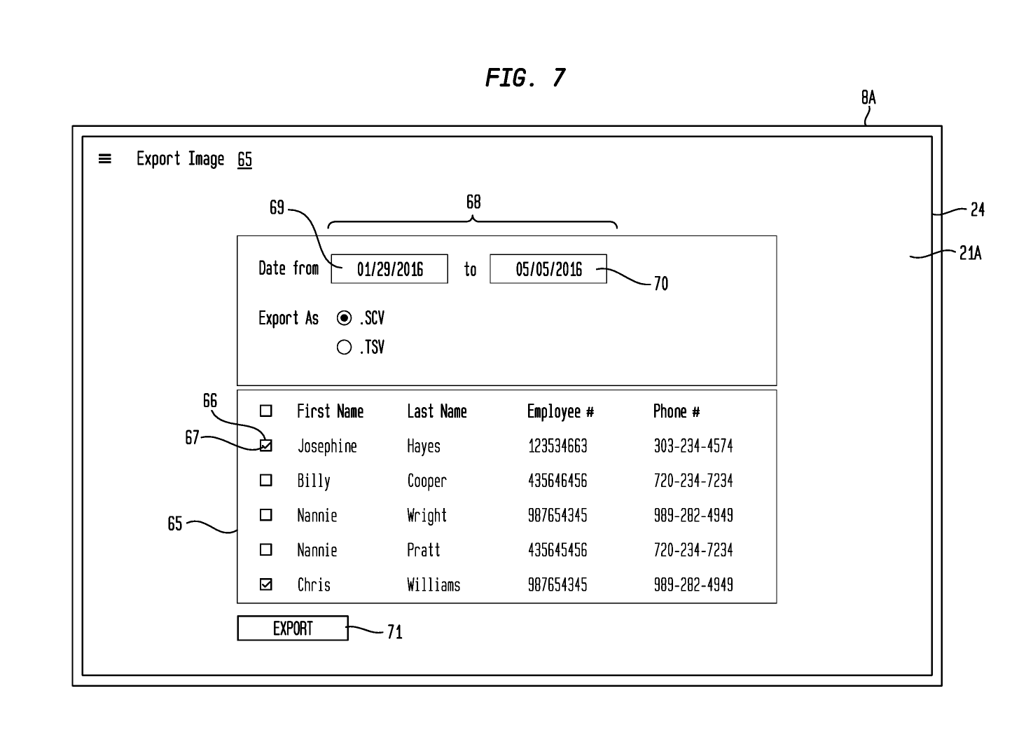

Now referring primarily to FIGS. 5 and 7, the administrator user (16A) can by user interaction (23) with an export icon (64)(as shown in the example of FIG. 5) can cause the program (19) to depict an export image (65) including a list of client users (16B) along with the associated client computer devices (8B) currently associated with the account (49)(as shown in the example of FIG. 7). The administrator user (16A) can by further user interaction (23) select one more of the client users (16B) and the associated client computing devices (8A) to monitor for unpermitted usage events (38). As shown in the example of FIG. 7, the administrator user (16A) can by user interaction (23) enter a check mark (66) in a check box (67) associated with a client user (16B) to select the corresponding client computing device (8B) to be monitored by the program (19). The administrator user (16A) can by user interaction (23) further limit monitoring of the selected client users (16B)(selected client computing devices (8B)) to a particular calendar period (68) by entry of the monitoring start date (69) and the monitoring end date (70). Accordingly, in the example shown in FIG. 7, the client computing devices (8B) associated with Josepine Hayes and Chris Williams will be monitored by operation of the program (19) beginning on Jan. 29, 2016 and ending on May 5, 2016. By administrator user (16A) interaction with the “export icon” (71), the program (19) can be executed to monitor the selected client computing devices (8B) within the calendar period (68).

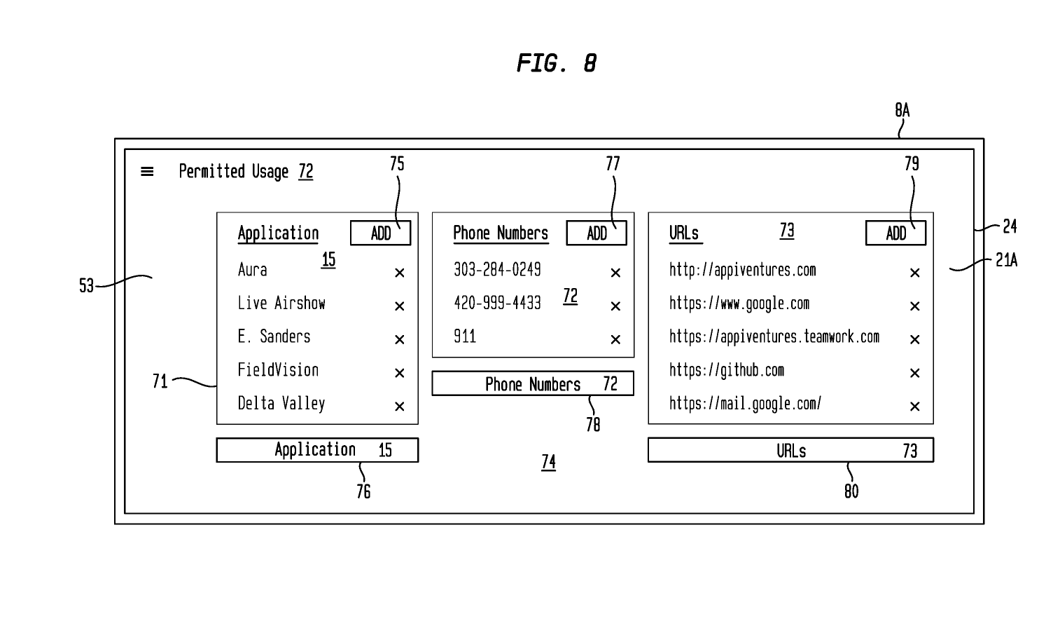

Now referring primarily to FIG. 8, the setup module (52) can further operate to depict a setup menu (53) including a permitted usage entry image (72) on the display surface (24) of the administrative computing device (8A) by which the administrative user (16A) can input applications (15), telephone numbers (72), and uniform resource locators (URLs) (73) that will either, not be monitored by the program (19), or if monitored by the program (19), the amount of time (42) associated with use of the input applications, telephone numbers and URLs, will not be utilized in the calculation of unpermitted usage time (74) associated with the client computing device (8B). As shown in the example of FIG. 8, the administrator user (16A) by interaction with an “application add” icon (75) can cause the program (19) to depict an application add field (76) into which applications (15) can be entered to identify applications (15) which will not be monitored by the program (19). Similarly, the administrator user (16A) by interaction with an “telephone numbers add” icon (77) can cause the program (19) to depict a telephone numbers add field (78) into which telephone numbers (72) can be entered to identify telephone numbers (72) which will not be monitored by the program (19). Similarly, the administrator user (16A) by interaction with a “URL add” icon (79) can cause the program (19) to depict a URL add field (80) into which URLs (73) can be entered to identify URLs (73) which will not be monitored by the program (19).

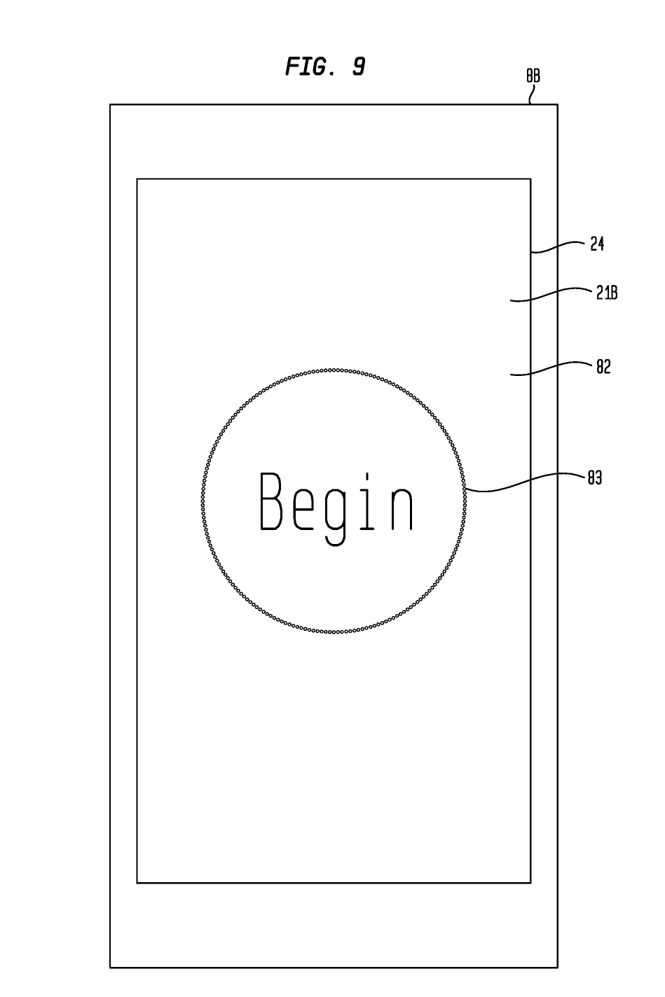

Now referring primarily to FIGS. 9 through 12, embodiments of the program (19) can further include a client computing device run time module (81) executable to depict a client computing device run time menu (82) on the display surface (24) of a client computing device (8B) including a monitoring start image (83) which by user interaction (23) starts monitoring of unpermitted usage events (38) by the client computing device (8B) computer utilization monitoring system (1).

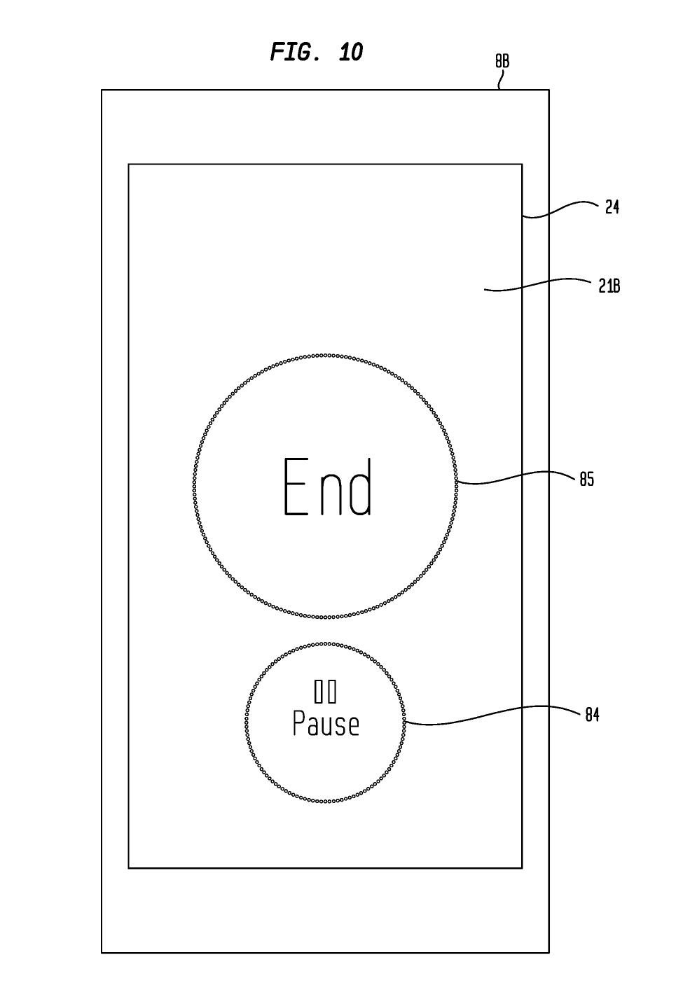

Now referring to the example of FIG. 10, the client computing device run module (81) can be executed to depict a pause monitoring image (84) on the display surface (24) of the client computing device (8B). By client user (16B) interaction with the pause monitoring image (84), the program (19) can pause monitoring unpermitted event usage (38) of the client computing device (8B).

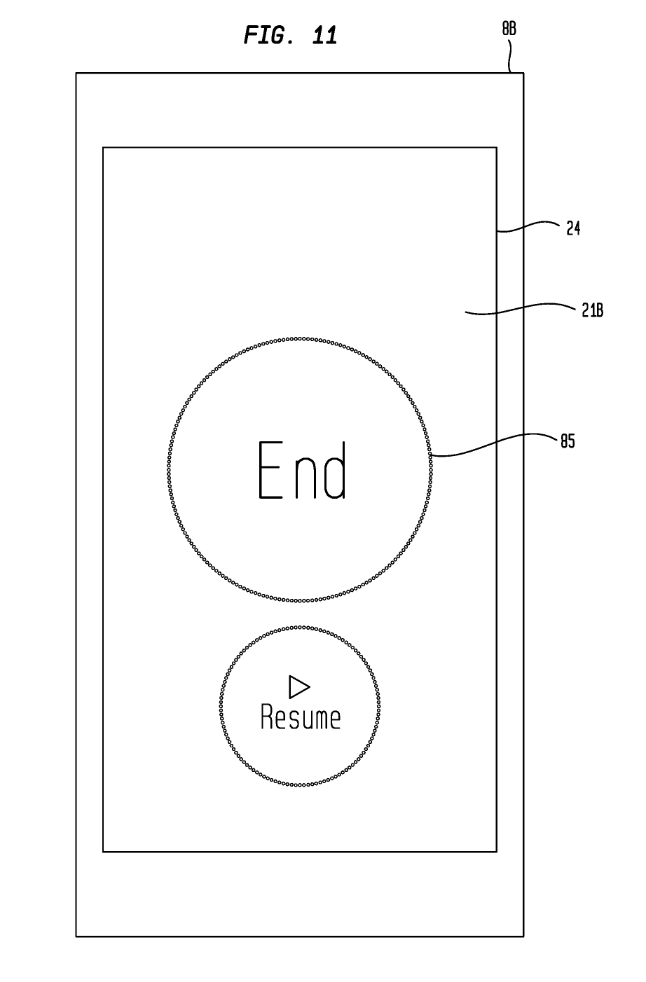

Now referring to the example of FIG. 11, the client computing device run module (81) can be executed to depict an end monitoring image (85) on the display surface (24) of the client computing device (8B). By client user (16B) interaction with the end monitoring image (85), the program (19) ends monitoring of unpermitted event usage (38) of the client computing device (8B).

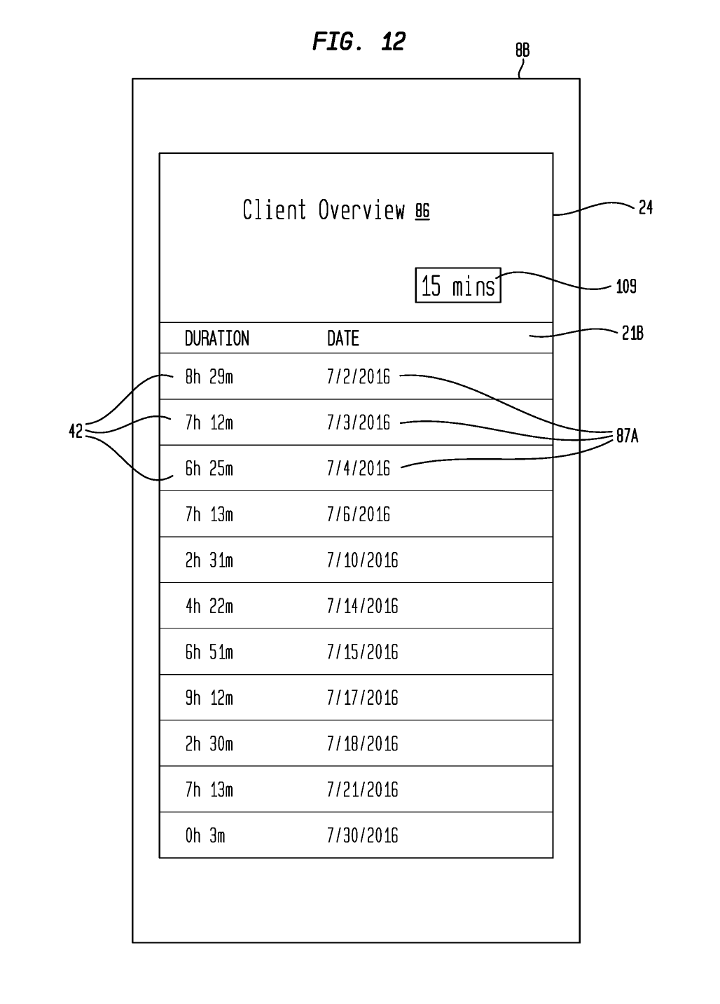

Now referring primarily to FIG. 12, the client computing device run module (81) can be executed to depict a client overview image (86) which for each calendar date (87A) depicts the unpermitted usage time (42) of the client computing device (8B). As to particular embodiments, the client computing device run module (81) can further operate to depict compliant unpermitted event usage time (109) consistent with usage parameters entered into the setup menu (53).

Now referring primarily to FIGS. 1 through 4, embodiments of the program (19) can further include an administrator computing device run time module (88) which operates to depict an administrator run time menu (89) on the display surface (24) of the administrator computing device (16A).

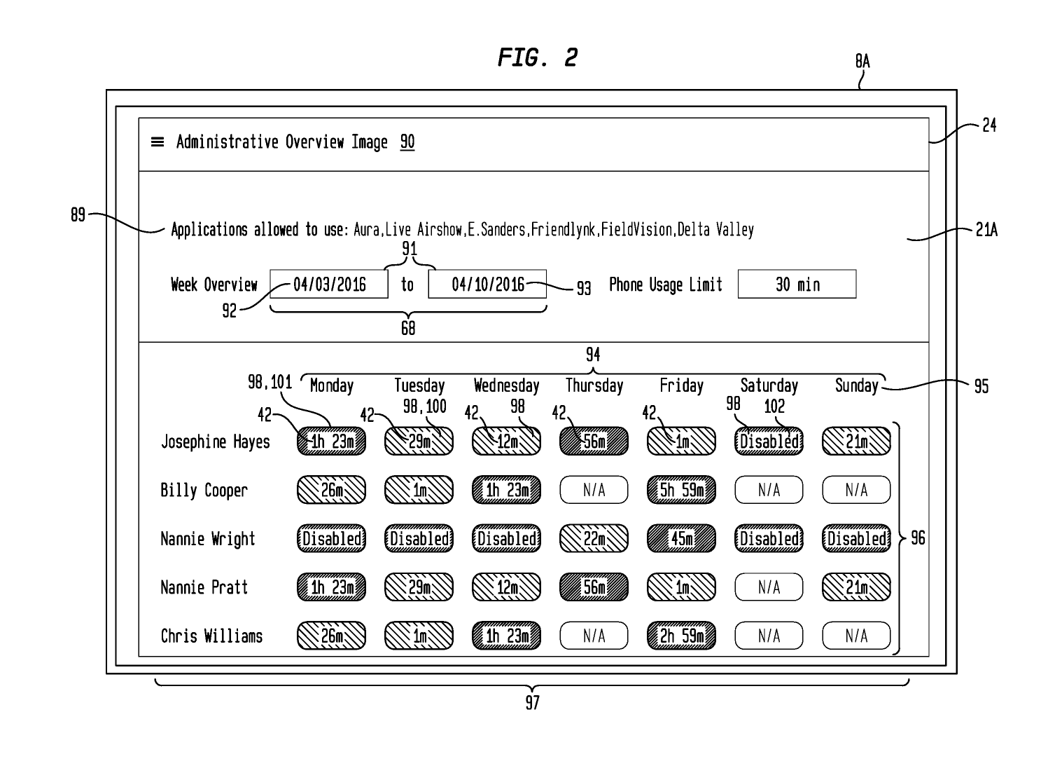

Now referring primarily to FIG. 2, the administrator computing device run time menu (88) can depict an administrator overview image (90) on the display surface (24) of the administrator computing device (8A). The administrator overview image (90) identifies each of the plurality of client computing device (8B) being monitored within a specified calendar period (68). In the illustrative example of FIG. 2, the administrator overview image (90) includes fillable calendar date fields (91) fillable with a begin calendar date (92) and an end calendar date (93). By entry of the begin calendar date (92) and end calendar date (93) the program (19) further operates to depict in the administrator overview image (90) a list of the client computing devices (8B) being monitored during the selected calendar period (68). The program (19) can further operate to divide the selected calendar period (68) into subdivisions of the calendar period (94) such as discrete calendar days (95)(as shown in the example of FIG. 2), consecutive 24 hour periods, work periods or other useful subdivision of the calendar period (68). As to the particular example of FIG. 2, the administrator overview image (90) includes a row (96) for each of the plurality of client computing devices (8B) being monitored in the selected calendar period (68). The subdivisions of the calendar period (68) divided into calendar days (95) defining plurality of columns (97) within each row (96).

As to each of the plurality of client computing devices (8B) being monitored, the program (19) can calculate and depict in the administrator overview image (90) of the administrator run menu (89) the unpermitted usage time (42) falling outside of permitted usage prior defined by entry of the permitted applications (15), phone numbers (72) and URLs (73) into the set up menu (53)(as above described and shown in the example of FIG. 8). As to those embodiments in which the program (19) depicts subdivisions of the calendar period (94), the program (19) can calculate the unpermitted usage time (42) accrued in each subdivision of the calendar period (94). As shown in the example of FIG. 2, the program (19) can calculate and depict in the administrator overview image (90) for each calendar day (95) the unpermitted usage time (42) which falls outside of the permitted usage parameters (74) prior defined in the setup menu (53).

Referring again to FIG. 2, the program (19) can operate to depict in the administrator overview image (90) one or more compliance indicia (98), other than the depicted unpermitted usage time (42), sensorially perceivable by the administrator user (16A) which indicate which of the plurality of client computing devices (8B) are not in compliance with permitted usage parameters (74) defined by administrator user (16A) by interaction in the setup menu (53). The compliance indicia (98) can be any sensorially perceivable indicia which the program (19) can generate in association with each of the plurality of client devices (8B) to distinguish compliant usage from non-compliant usage. As one example, differently colored fields (99) can be associated with each calendar period (68) or subdivision of the calendar period (94), whether discrete from or associated with the unpermitted usage time (42), to distinguish compliant usage (for example a green colored field (100) from non-compliant usage (for example a red colored field (101)). As to particular embodiments a compliance threshold of unpermitted event usage (108) can be depicted in the administrator overview image (90).

Referring again to FIG. 2, the program (19) can operate to depict in the administrator overview image (90) disabled indicia (102), sensorially perceivable the administrator user (16A), which indicate which of the plurality of client computing devices (8B) are not enabled or are disconnected from the program (19). The disabled indicia (102) can be any sensorially perceivable indicia which the program (19) can generate in association with each of the plurality of client devices (8B) to distinguish client computing devices (8B) which enable the program (1) from those that have disabled the program (19).

There can be an advantage to having the administrator run menu (89) configured as an administrator overview image (90), as above described, because the administrator user (16A) can readily identify which of the plurality of client computing devices (8B) have disabled or disconnected from the program (19) and concurrently readily identify which of the plurality of client computing devices (8B) have unpermitted event usage non-compliant with usage parameters entered into the setup menu (53).

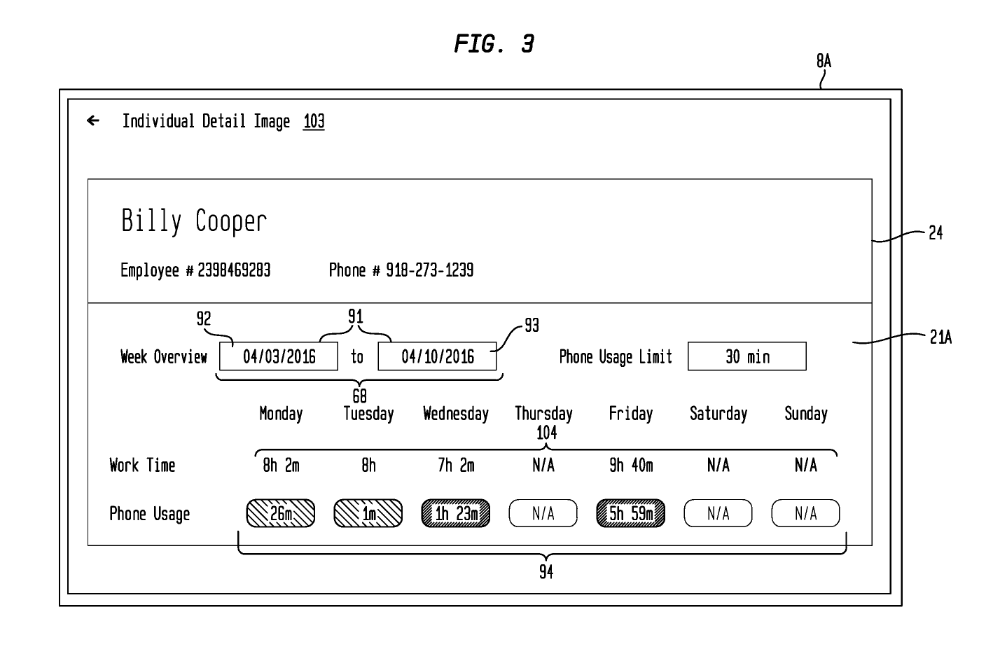

Now referring primarily to FIGS. 2 and 3, the program (19) can be further executed by selection of one of the plurality of client computing devices (8B) listed in the administrator overview image (90) to separately depict a detail image (103) including unpermitted event usage of the selected client computing device (8B) (as shown in the example of FIG. 3). The depiction in the detail image (103) can be in substantially the same format device as shown and above described for the administrator overview image (90) shown in FIG. 2. By operation of the program (19), the detail image (103) can include for each subdivision of the calendar period (94), the monitored duration of time (104) and the accrued unpermitted event usage time (42) in each subdivision of the calendar period (94) which fall outside of the permitted usage parameters (74) entered into the setup menu (53) for the client computing device (8B).

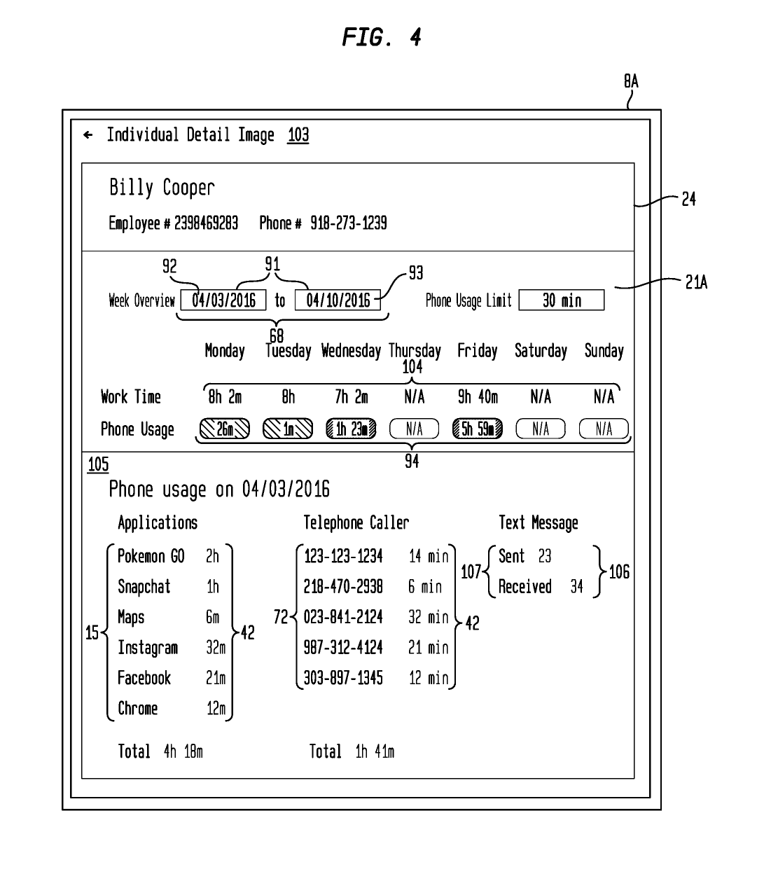

Now referring primarily to FIGS. 3 and 4, as to particular embodiments, a particular calendar period (68), or subdivision of the calendar period (94), can be selected by user interaction (23) in the detail image (103) whether by entering a particular calendar date (86) in the fillable calendar date fields (91) or by interaction with represented subdivision of the calendar period (94). In the example of FIG. 3, the administrator user (16A) by interaction subdivision of the calendar period (94) (shown in the example of FIG. 3 as “Friday”) can cause the administrator run module (88) to concurrently further depict in detail image (103) a usage report (105) generated by retrieving the permitted usage events (38) stored in the local database (46A) of the client computing device (8B). As shown in the example of FIG. 4, the usage report (105) generated by the administrator run module (88) can depict a list of applications (15), a list of telephone calls (72), and a list of text messages (44). The administrator run time module (88) can further depict the unpermitted usage time (42) associated with each application (15), telephone call (72) or depict a numerical indicator (106) associated with the number text messages (107) sent or received.

As can be easily understood from the foregoing, the basic concepts of the present invention may be embodied in a variety of ways. The invention involves numerous and varied embodiments of an computer utilization monitoring system and methods for making and using such computer utilization monitoring system including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “time tracker” should be understood to encompass disclosure of the act of “tracking time”—whether explicitly discussed or not—and, conversely, were there effectively disclosure of the act of “tracking time”, such a disclosure should be understood to encompass disclosure of a “time tracker” and even a “means for time tracking.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in Webster's Unabridged Dictionary, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or entity refers to one or more of that entity unless otherwise limited. As such, the terms “a” or “a” “one or more” and “at least one” can be used interchangeably herein.

Thus, the applicant(s) should be understood to claim at least: i) each of the computer utilization monitoring systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

We claim:

1. A computer implemented system, comprising
a memory element containing a program;
a processor communicatively coupled to said memory element, said program executable by said processor to:
communicatively couple a plurality of client computer devices to an administrator computing device;
depict a graphical user interface on the display surface of said administrator computing device, said graphical user interface including a setup menu which by user interaction receives indications of permitted event usage and indications of a compliance threshold of unpermitted event usage time allocated to each one of said plurality of client computer devices;
interrogate each one of said plurality of client computing devices over a time period to retrieve data associated with unpermitted event usage;
calculate unpermitted event usage time of each one of said plurality of client computers using said data associated with unpermitted event usage;
depict an administrator run time menu on said surface of said administrator computing device which includes a list of said plurality of client computer devices communicatively coupled to said administrator computer;
depict unpermitted event usage time of each of said plurality of computer devices within said time period; and
generate a non-compliance indicia associated with each depiction of said unpermitted event usage time exceeding the compliance threshold of unpermitted event usage time allocated to each one of said plurality of client computer devices.
